(19) United States
(12) Patent Application Publication
(10) Pub. No.: US 2012/0025941 A1
(43) Pub. Date: Feb. 2, 2012

(54) IRON-CORE COIL ASSEMBLY

(75) Inventors: Ching-Shun Wang, TamShui (TW); Chun-Hua Hsia, TamShui (TW); Yuan-Bin Tang, TamShui (TW)

(73) Assignee: Advanced Connection Technology, Inc., TamShui (TW)

(21) Appl. No.: 12/897,832

(22) Filed: Oct. 5, 2010

(30) Foreign Application Priority Data
Jul. 28, 2010 (TW) 99214405

(51) Int. Cl. H01F 27/30

(52) U.S. Cl. 336/196

(57) ABSTRACT

An iron-core coil assembly is provided, which includes a substrate, a plurality of U-shaped wires, a first pin, a second pin, and an iron-core device. The substrate has a groove divided into a winding area and a non-winding area. The plurality of U-shaped wires is disposed in the winding area at a space from each other, and each U-shaped wire has an opening and a recess. The first pin and the second pin are respectively arranged at two ends of the opening, and the recess is located in the groove. The iron-core device is disposed in the groove, and passes through the recess of each U-shaped wire.

### CROSS-REFERENCES TO RELATED APPLICATIONS

This non-provisional application claims priority under 35 U.S.C. §119(a) on Patent Application No. 99214405 filed in Taiwan, R.O.C. on 2010/7/28, the entire contents of which are hereby incorporated by reference.

### BACKGROUND OF THE INVENTION

1. Field of Invention

The present invention relates to an iron-core coil assembly, and more particularly to an iron-core coil assembly formed by arranging a groove and U-shaped wires on a substrate, and embedding an iron-core device into the groove.

2. Related Art

An iron-core coil assembly is generally used to fabricate an electronic device or apparatus, such as an inductor, an electrical transformer, and a common mode choke. The traditional process for fabricating the iron-core coil assembly includes winding a wire having an insulating layer coated on its surface (for example, enameled wire), onto a specific winding area of an iron-core device. In order to lower the leakage inductance and magnetic flux loss, a closed (ring-shape), iron-core device must be used in most cases, which not only solves the leakage inductance and magnetic flux loss problems mentioned previously, but also avoids interference caused by the introduction of external magnetic lines of force into the iron-core device. However, the difficulty involved in winding wire onto the surface of the closed iron-core device is also increased greatly.

Furthermore, the enameled wires used by the traditional winding machine dedicated to wind a wire (enameled wire), onto the surface of an iron-core device are limited by diameter, since slender enameled wire which is too thin can easily break during the winding process. Where the diameter of the enameled wire cannot be reduced any further, the size of the iron-core coil assembly is accordingly limited, and further miniaturization becomes difficult.

In order to solve the difficult winding problem of the closed iron core, in the prior art a combined iron core is used, that is, an iron core is divided into two or a plurality of parts, which are joined together after winding. However, using such a method the enameled wire must also be wound circle by circle on the winding area of the iron-core device manually or with the aid of a machine, which not only prolongs the preparation process unnecessarily, but also leads to a lowered inductance value of the whole iron-core coil assembly due to non-uniform surfaces (junction), formed by joining the iron cores.

The problems related to winding and the difficulties of further miniaturization of the conventional iron-core coil assembly are therefore expected to be solved by persons of skill in the art.

### SUMMARY OF THE INVENTION

In view of the problems in the prior art, the present invention is directed to an iron-core coil assembly which includes a substrate, a plurality of U-shaped wires, a first pin, a second pin, and an iron-core device. The substrate has a groove divided into a winding area and a non-winding area. The plurality of U-shaped wires is disposed in the winding area, with the wires separated from each other, each U-shaped wire has an opening and a recess, and the recess is located in the groove. The first pin and the second pin are respectively arranged at two ends of the opening. The iron-core device is disposed in the groove, and passes through the recess of each U-shaped wire.

Therefore, depending on the size of the desired inductance value, a certain number of U-shaped wires are interposed (molded) in at least one winding area of the groove in advance with the opening facing upward, the iron-core device having a closed magnetic loop is placed in the groove, such that the iron-core device passes through the recess of each U-shaped wire, thereby modifying the inconvenience caused by the necessary winding of the iron-core device circle by circle in the prior art.

Since use of a winding machine is no longer necessary, the size of the iron-core coil assembly is not limited by a winding machine, and thus can be miniaturized further.

As described above, the present invention solves the problems related to winding and difficulty of further miniaturization in the prior art. The embodiments of the present invention and effects thereof are described below with reference to drawings.

### BRIEF DESCRIPTION OF THE DRAWINGS

The present invention will become more fully understood from the detailed description given herein below for illustration only, and thus not limitative of the present invention, wherein:

FIG. 1 is an exploded view of a first embodiment according to the present invention;

FIG. 2 is a combined view (1) of the first embodiment of the present invention;

FIG. 3 is a combined view (2) of the first embodiment of the present invention;

FIG. 4 is a schematic view (1) of a connection portion according to the first embodiment of the present invention;

FIG. 5 is a schematic view (2) of the connection portion according to the first embodiment of the present invention;

FIG. 6 is a schematic view (1) of a connection portion according to a second embodiment of the present invention;

FIG. 7 is a schematic view (2) of the connection portion according to the second embodiment of the present invention;

FIG. 8 is an exploded view of a third embodiment of the present invention;

FIG. 9 is a combined view (1) of the third embodiment of the present invention;

FIG. 10 is a combined view (2) of the third embodiment of the present invention;

FIG. 11 is a schematic view (1) of a connection portion according to the third embodiment of the present invention;

FIG. 12 is a schematic view (2) of the connection portion according to the third embodiment of the present invention;

FIG. 13 is an exploded view of a fourth embodiment of the present invention;

FIG. 14 is a combined view (1) of the fourth embodiment of the present invention; and

FIG. 15 is a combined view (2) of the fourth embodiment of the present invention.

### DETAILED DESCRIPTION OF THE INVENTION

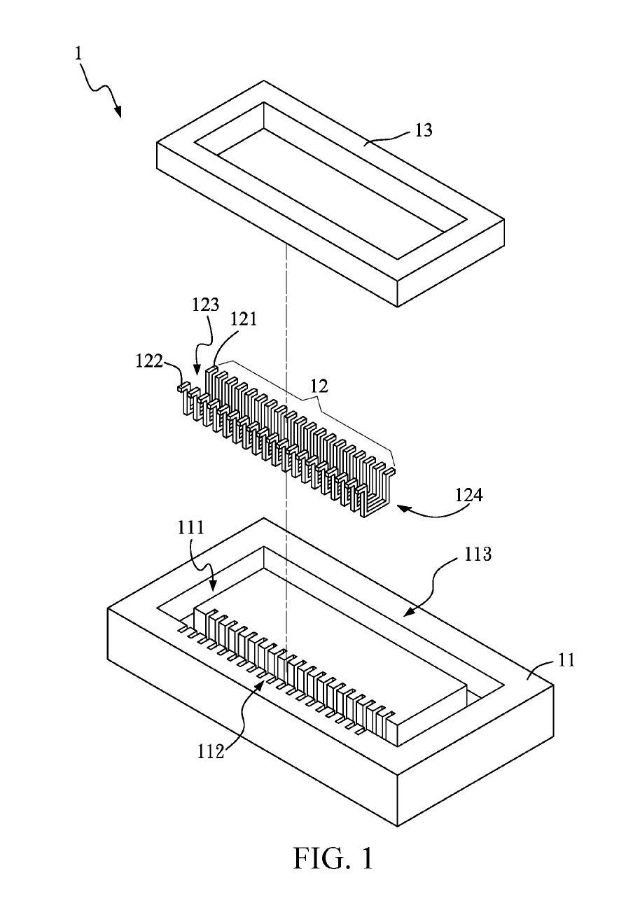

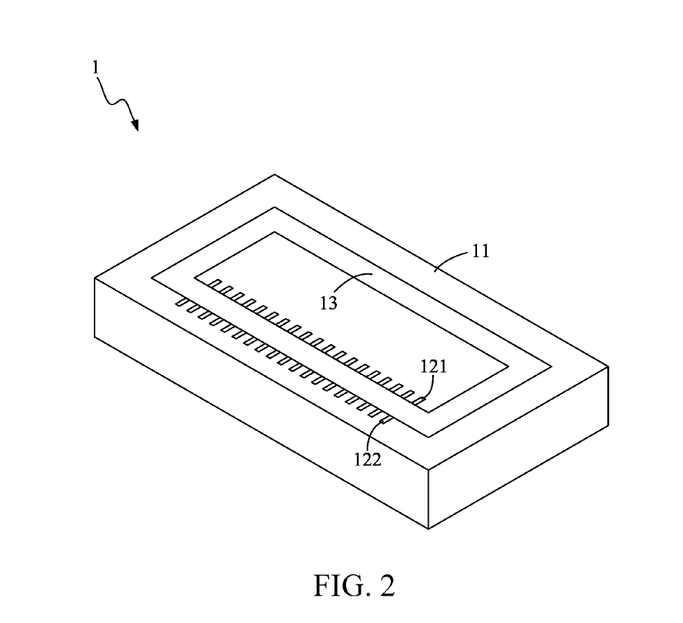

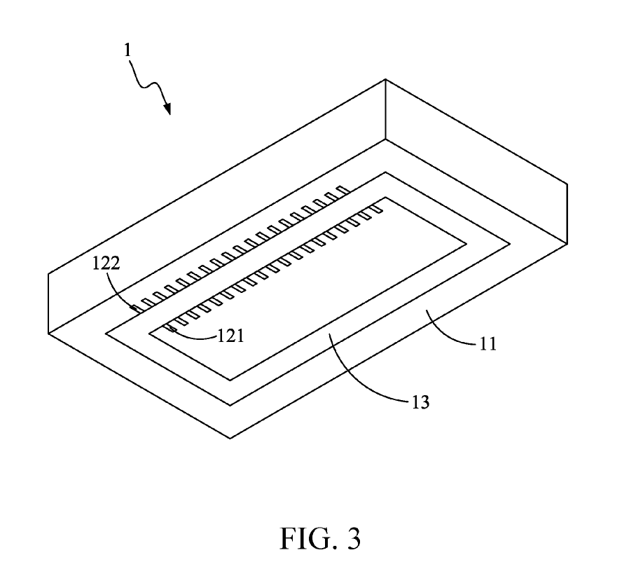

FIGS. 1-3 are respectively an exploded view, a combined view (1) and a combined view (2) of a first embodiment of the present invention. Please refer to FIGS. 1-3, in which the first embodiment of the present invention includes a substrate 11, a plurality of U-shaped wires 12, and an iron-core device 13. The substrate 11 has a groove 111 divided into a winding area 112 and a non-winding area 113. The U-shaped wires 12 are disposed in the winding area 112 at a fixed space, each U-shaped wire has an opening 123 and a recess 124. A first pin 121 and second pin 122 are respectively arranged at two ends of the opening 123, and the recess 124 is located in the groove 111. The iron-core device 13 is disposed in the groove 111, and passes through the recess 124 of each U-shaped wire 12. As such, a coil surrounding the iron-core device 13 can be formed just by electrically connecting the first pin 121 of the U-shaped wire 12 to the second pin 122 of the abutting U-shaped wire 12. When more first pins 121 of the U-shaped wires 12 are electrically connected to the second pins 122 of the abutting U-shaped wires 12, turn number of the coils surrounding the iron-core device 13 can be increased, thereby improving an inductance value of an iron-core coil assembly 1.

This embodiment is especially suitable as an inductor device, in which the used iron-core device 13 is closed, and has low magnetic flux loss property, and a U-shaped slot may be further arranged in the winding area 112 of the groove 111, so as to firmly dispose the U-shaped wires 12 in the winding area 112.

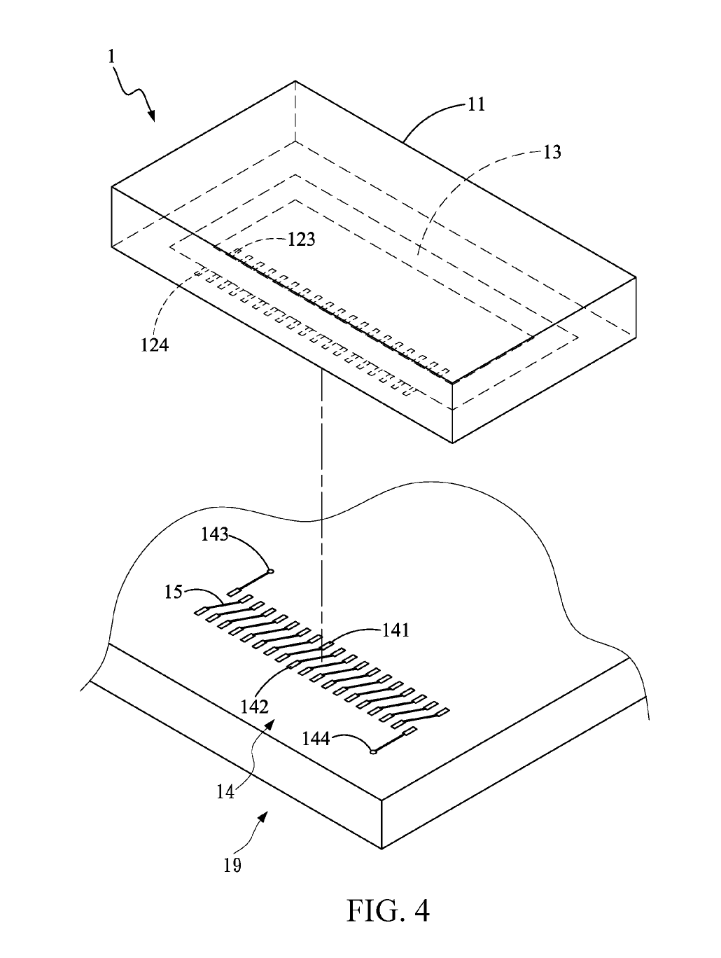

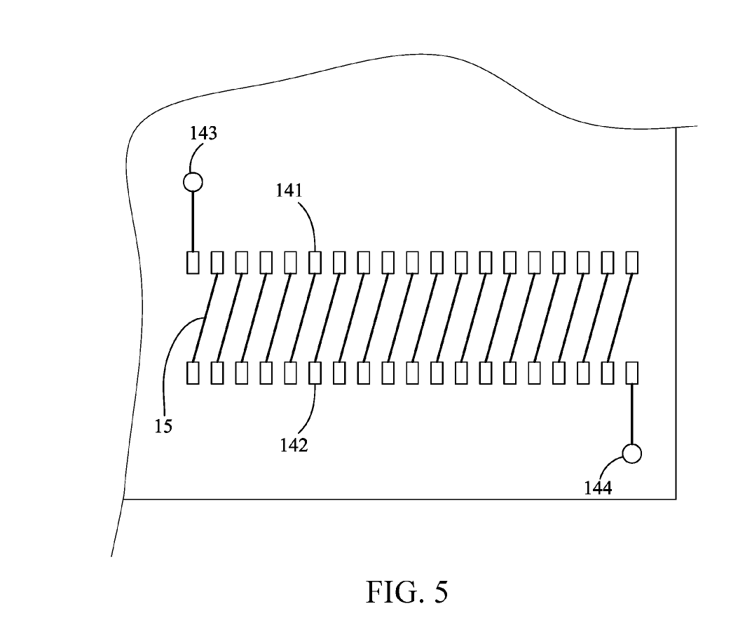

FIGS. 4-5 are respectively a schematic view (1) and a schematic view (2) of a connection portion according to the first embodiment of the present invention. Please refer to FIGS. 4-5, in which embodiment the first pin 121 of the U-shaped wire 12 is indirectly electrically connected, through a connection portion 14 on a printed circuit board (PCB) 19, to the second pin 122 of the abutting U-shaped wire 12. The connection portion 14 is coupled to the U-shaped wires 12, and has a plurality of first pin positions 141 and a plurality of second pin positions 142, in which the plurality of first pin positions 141 is individually electrically connected to the first pins 121 of the plurality of U-shaped wires 12; and the plurality of second pin positions 142 is individually electrically connected to the second pins 122 of the plurality of U-shaped wires 12. Furthermore, this embodiment further includes a plurality of first lines 15 disposed in parallel at a space from each other, in which the two ends of each first line 15 are respectively electrically connected to the first pin position 141 and the second pin position 142 next to the first pin position 141. In this way, the U-shaped wire 12 may electrically communicate with the abutting U-shaped wire 12 and thus form a coil structure surrounding the iron-core device 13 by the bridging of the connection portion 14 and the first line 15, in which an electrical signal is input from a first signal contact 143, and output from a second signal contact 144, or vice versa.

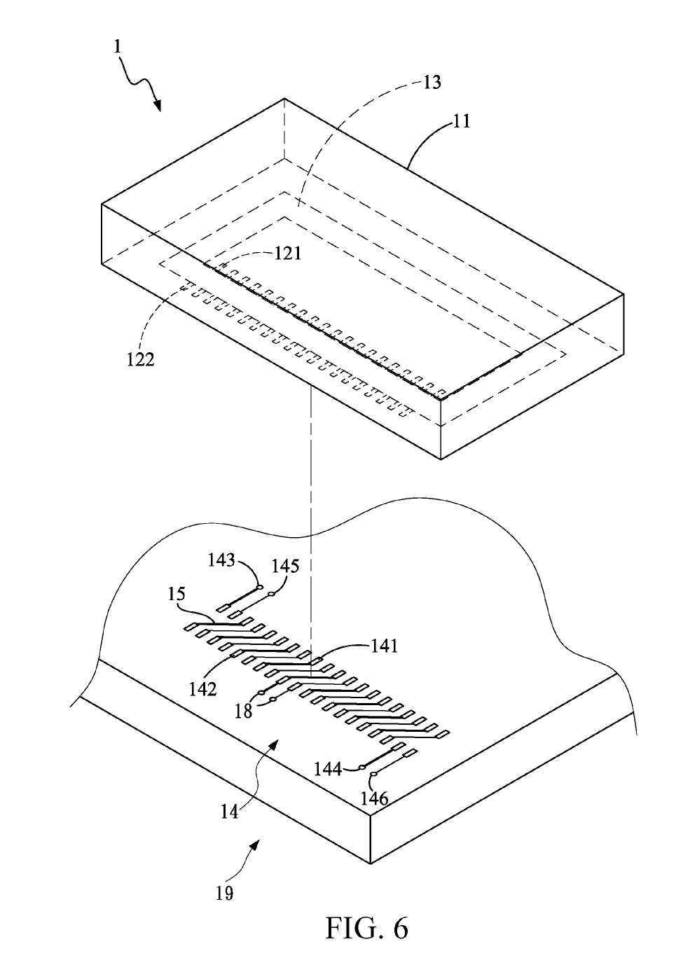

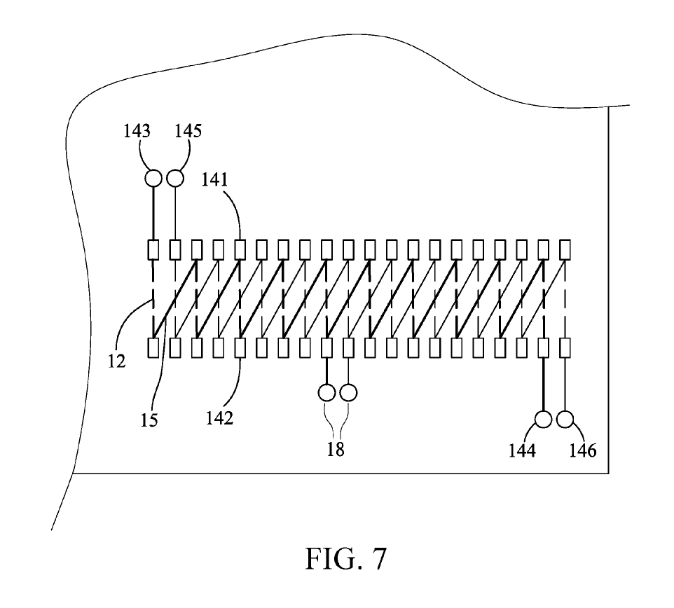

FIGS. 6-7, are respectively a schematic view (1) and a schematic view (2) of a connection portion according to a second embodiment of the present invention. Please refer to FIGS. 6-7, which embodiment is different from the first embodiment by virtue of the different wiring means of the first lines 15. By altering the wiring means of the first lines 15, a plurality of U-shaped wires 12 and the first lines 15 are separated into two independent coil structures, and the U-shaped wires 12 and the first lines 15 contained in each coil structure are connected in series to each other to form a single circuit loop. In one coil structure, an electrical signal is input from a first signal contact 143, and output from a second signal contact 144; and in the other coil structure, an electrical signal is input from a third signal contact 145, and then output from a fourth signal contact 146. A dot line in FIG. 7 indicates a connection relation between the U-shaped wires 12 and the first lines 15 when an iron-core coil assembly 1 and a connection portion 14 are combined in this embodiment. In this embodiment, the two coil structures have the same number of the U-shaped wires 12 and the first lines 15; however, the two coil structures also can be designed as desired, so as to have different numbers of the U-shaped wires 12 and the first lines 15. Moreover, in this embodiment center taps 18 are respectively arranged on the connection portion 14 for the two coil structures.

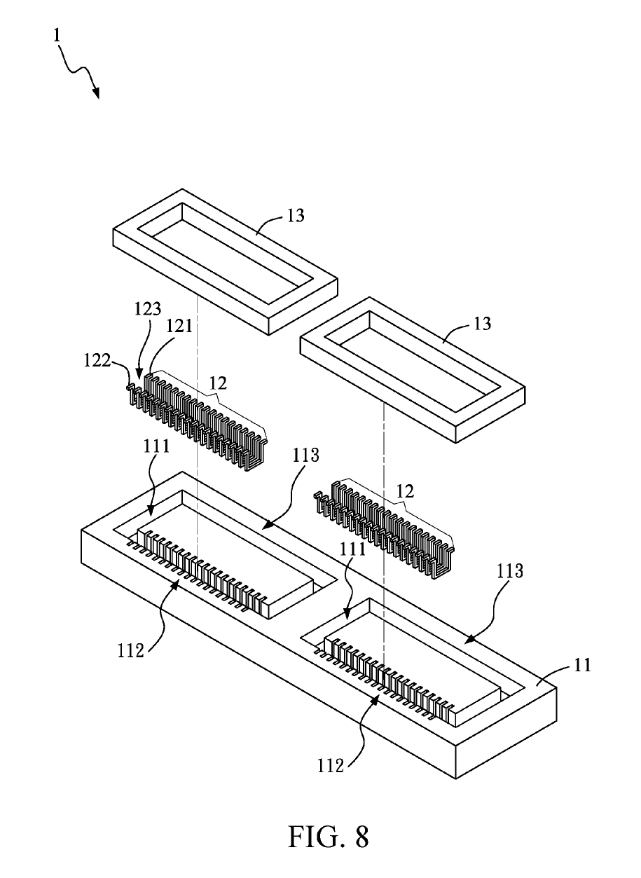

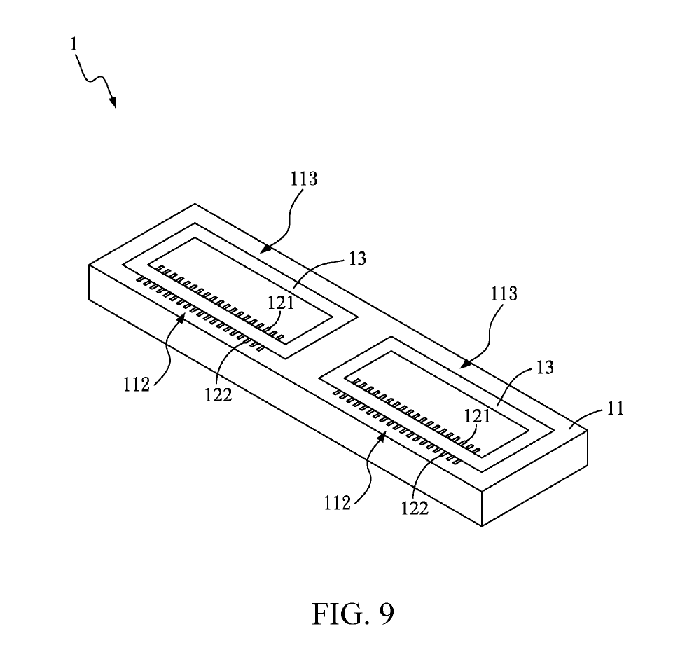

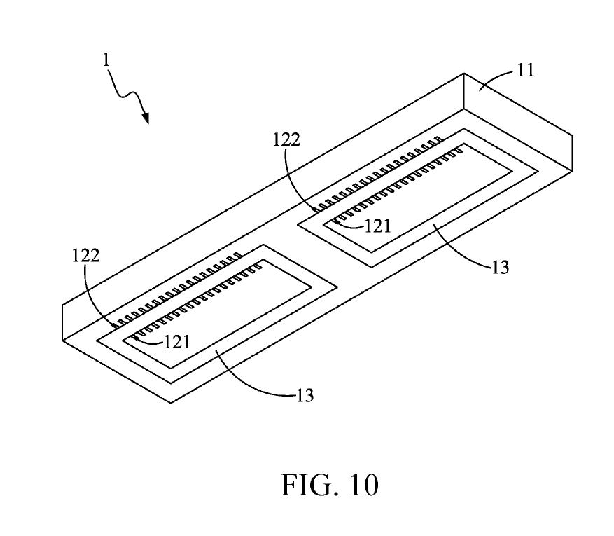

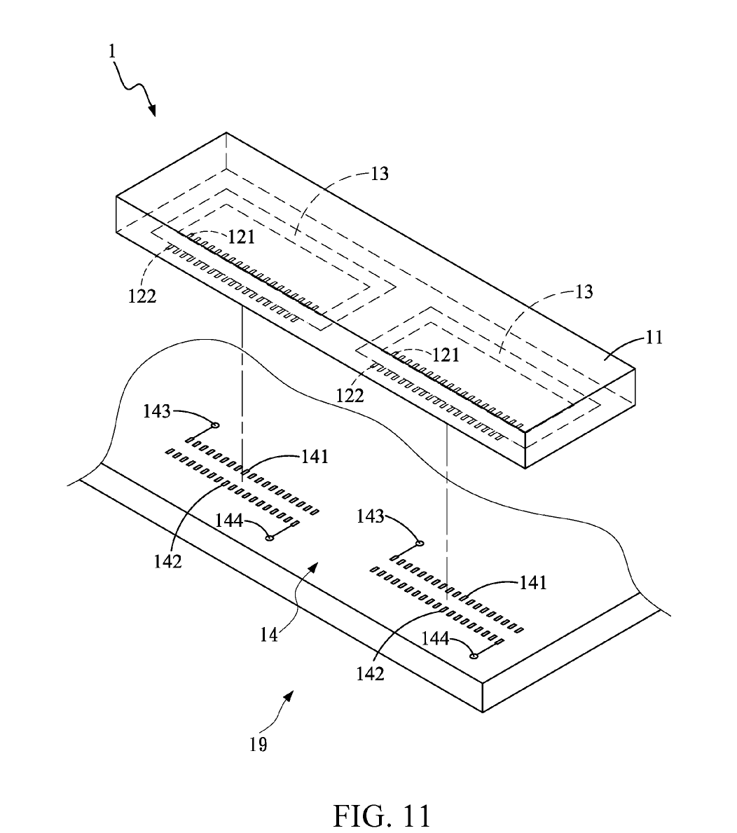

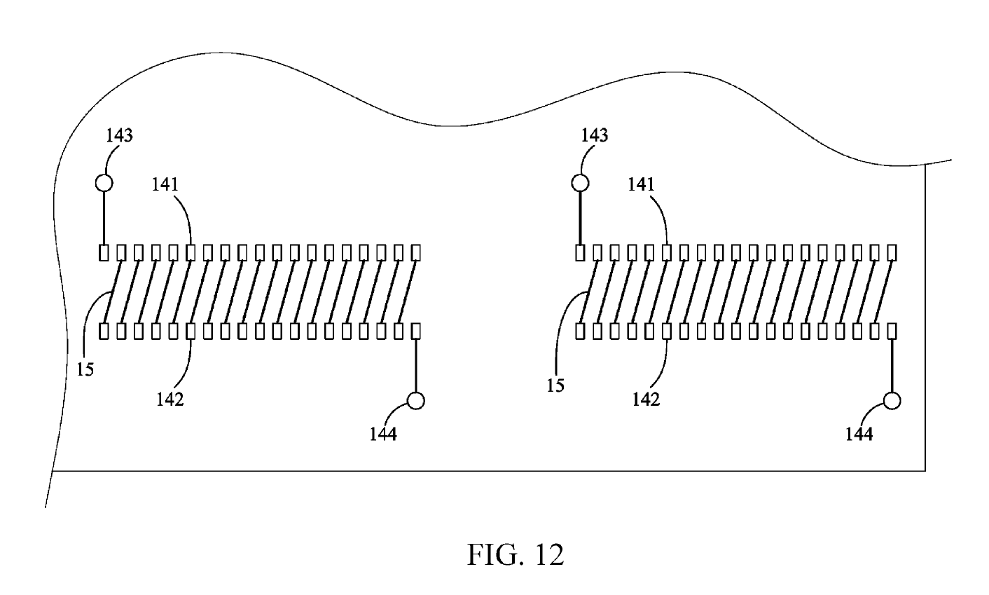

FIGS. 8-10 are respectively an exploded view, a combined view (1) and a combined view (2) of a third embodiment of the present invention. Please refer to FIGS. 8-10, in which the main difference between this embodiment and the first embodiment is a substrate 11 having two grooves 111 and two iron-core devices 13. As shown in FIGS. 11-12, similar to the above embodiments, the U-shaped wires 12 of this embodiment can also form a coil structure surrounding the iron-core device 13 by connecting U-shaped wires 12 coupled to a connection portion 14 and a plurality of first lines 15.

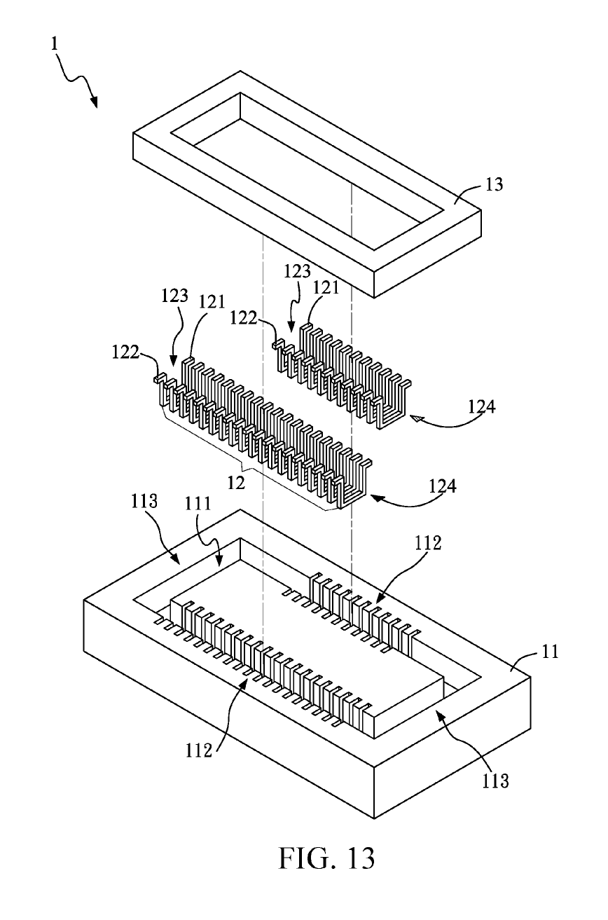

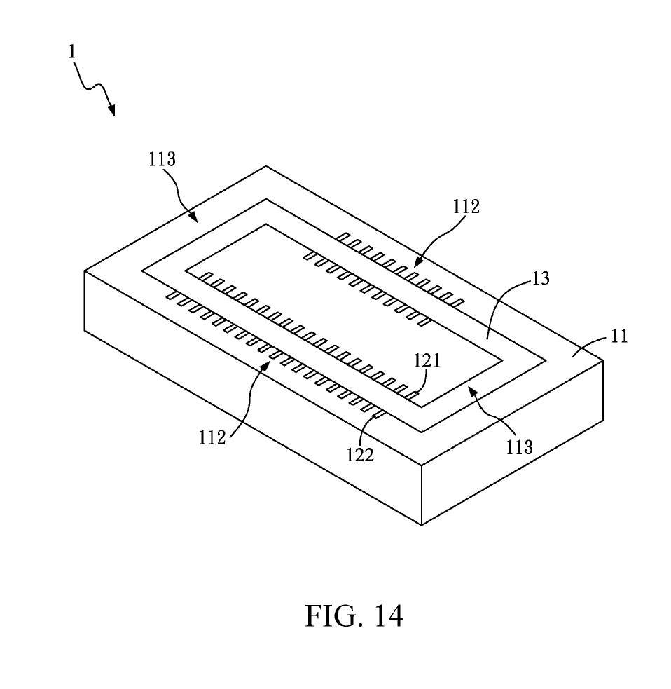

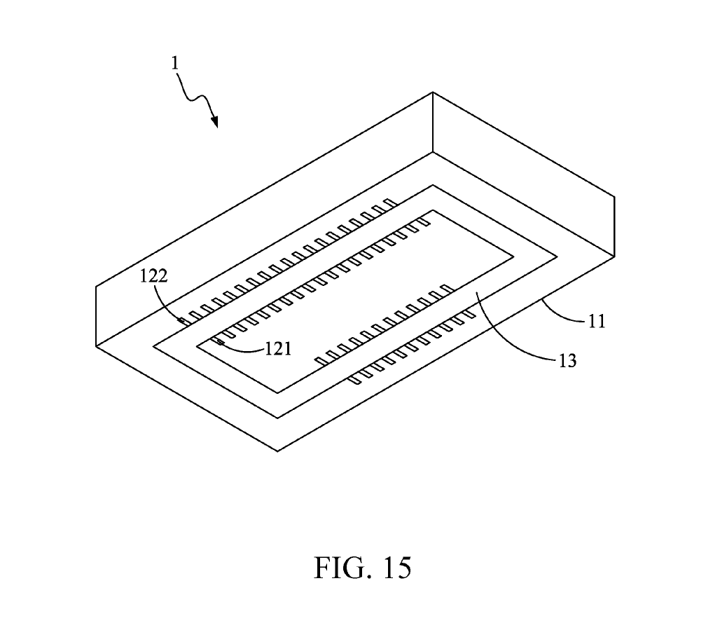

FIGS. 13-15 are respectively an exploded view, a combined view (1) and a combined view (2) of a fourth embodiment of the present invention. Please refer to FIGS. 13-15, in which the main difference between this embodiment and the first embodiment is a groove 111 which may be divided into two winding areas 112 and two non-winding areas 113. In this embodiment, the number of U-shaped wires 12 in the two winding areas 112 is different, but may be designed to be identical as desired.

While the present invention has been described by the way of example and in terms of the preferred embodiments, it is to be understood that the invention need not to be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. An iron-core coil assembly, comprising:
a substrate, comprising at least one groove divided into at least one winding area and at least one non-winding area;
a plurality of U-shaped wires, disposed in the winding area at a space from each other, and each having an opening and a recess, wherein the recess is located in the groove;
a first pin and a second pin, respectively arranged at two ends of the opening; and
an iron-core device, disposed in the groove, and passing through the recess of each U-shaped wire.

2. The iron-core coil assembly according to claim 1, further comprising:
a connection portion, coupled to the U-shaped wires, and comprising a plurality of first pin positions and a plurality of second pin positions, wherein the first pin positions are individually electrically connected to the first pin, and the second pin positions are individually electrically connected to the second pin.

3. The iron-core coil assembly according to claim 2, further comprising:
a plurality of first lines, disposed in parallel at a space from each other, wherein two ends of each first line are respectively electrically connected to the first pin position and the second pin position next to the first pin position.

4. The iron-core coil assembly according to claim 3, wherein the U-shaped wires and the first lines are separated into a plurality of coil structures, and the U-shaped wires and the first lines comprised in each coil structure are connected in series to each other to form a single circuit loop.

5. The iron-core coil assembly according to claim 4, wherein a number of the U-shaped wires in at least one of the coil structures is different from that of the U-shaped wires in the rest of the coil structures.

6. The iron-core coil assembly according to claim 4, wherein a number of the first lines in at least one of the coil structures is different from that of the first lines in the rest of the coil structures.

7. The iron-core coil assembly according to claim 2, wherein the connection portion comprises a center tap.
